(19) United States
(12) Patent Application Publication
(10) Pub. No.: US 2023/0339734 A1
(43) Pub. Date: Oct. 26, 2023

(54) OBJECT DETECTION SYSTEM AND METHOD ON A WORK MACHINE

(71) Applicant: Deere & Company, Moline, IL (US)

(72) Inventors: Scott R. Stahle, Dubuque, IA (US); Doug M. Lehmann, Centralia, IA (US); Rachel Bruflodt, Dubuque, IA (US); Samantha F. Echaves, Dubuque, IA (US); Harry E. Rawlins, Dubuque, IA (US); Giovanni A. Wuisan, Epworth, IA (US)

(21) Appl. No.: 17/660,739

(22) Filed: Apr. 26, 2022

(51) Int. Cl. B60W 50/14; G06V 20/58; B66F 9/075; B60W 30/182; B60K 35/00

(52) U.S. Cl. CPC B66F 9/0755; B60K 35/00; B60W 30/182; B60W 50/14; G06V 20/58; B60K 2370/119; B60K 2370/176; B60K 2370/179; B60W 2050/146; B60W 2300/121; B60W 2420/42; B60W 2554/80; B60W 2556/45; G06V 2201/07

(57) ABSTRACT

A method and system of controlling a work machine having an object detection system. The method comprises capturing an image with a camera and then recognizing an object in the image with the object detection. In next steps, the method includes defining the recognized object as a target object and operating the work machine wherein the object detection system is configured to execute a function of the work machine when the object is recognized. Finally, the method includes overriding the execution of the function of the object detection system when the object is defined as the target object.

### TECHNICAL FIELD

The disclosure generally relates to an object detection system and method on a work machine.

### BACKGROUND

Work machines are configured to perform a wide variety of tasks for use as construction machines, forestry machines, lawn maintenance machines, as well as on-road machines such as those used to plow snow, spread salt, or machines with towing capability. Accordingly, different attachments may be coupled to the work machine such as a bucket, rotary attachments, plows, spreaders, and transport. The work machines are therefore equipped with one or more interfaces to which different attachments may be coupled. Such interfaces may include a hitch in the rear of the work machine, or a Quick-Tach coupler in the forefront of the work machine, for example. When coupling an attachment to a work machine, an object detection system coupled to the work machine may result in a false positive and therefore disrupt the flow of function. Therein lies an opportunity to improve function for a more efficient operation.

### SUMMARY

An object detection system and method therefore are disclosed. The object detection system comprises of a frame, a boom arm coupled to the frame, an image sensor, a processor, and a controller. The image sensor is coupled to one of the boom arm and the frame for capturing an image. The processor is communicatively coupled to the image sensor and recognizes an object in the image. The controller is configured to execute a function of the work machine when the object is recognized; and override execution of the function of the work machine when the object is defined as the target object.

The system may further comprise a display device displaying an icon representing the recognized object on a display device. Defining the recognized object as the target object may include manually selecting the icon displayed on the display device. Alternatively, defining the recognized object as the target object includes the controller automatically defining the recognized object as the target object based on one of identification as a pre-defined object stored in a memory, or identification as a previously defined target object.

Additionally, the object stored in memory may be received from one of a second work machine, a worksite control center, and a predefined program.

Recognition of the object occurs within a defined space relative to the work machine, wherein the defined space being up to a predefined distance from the work machine.

Additionally, a target object may be untargeted if the target object falls outside a field of view on the display device.

A function of the work machine may comprise one of alerting an operator, stopping the work machine, modifying a current travel speed of the work machine, and steering the work machine.

The method of controlling a work machine having an object detection system includes capturing an image with an image sensor, recognizing an object in the image with the object detection system, defining the recognized object as a target object, operating the work machine and overriding a function of the object detection system when the object is defined as the target object. The target object may further become untargeted if the target object falls outside a field of view on the display device. The function of the object detection system may comprise one or more object avoidance and object engagement. A function of the object detection system may include of alerting an operator, stopping the work machine, modifying a current travel speed of the work machine, and steering the work machine.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a side view of one embodiment of a work machine, shown as a skid steer.

FIG. 2 is a block diagram of the system architecture and the flow of the object detection system.

FIG. 3A is an exemplary view of a display device showing the field of view from the image sensor with a recognized object shown as a pallet.

FIG. 3B is an exemplary view of a display device showing the field of view from the image sensor with a recognized object shown as a hitch.

FIG. 3C is an exemplary view of the display device in FIG. 3A with a target object.

FIG. 3D is an exemplary view of the display device in FIG. 3B with a target object.

FIG. 4 is an exemplary view of a worksite using the object detection system.

FIG. 5 is a top view of the work machine shown in FIG. 1 demonstrating a defined space within a predefined distance from the work machine.

FIG. 6 is a method of controlling a work machine having an object detection system.

FIG. 7 is a flow diagram illustrating one embodiment of the object detection system.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

As used herein, unless otherwise limited or modified, lists with elements that are separated by conjunctive terms (e.g. “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

As used herein, “controller” 66 is intended to be used consistent with how the term is used by a person of skill in the art, and refers to a computing component with processing, memory, and communication capabilities, which is utilized to execute instructions (i.e., stored on the memory 90 or received via the communication capabilities) to control or communicate with one or more other components. In certain embodiments, the controller 66 may be configured to receive input signals in various formats (e.g., hydraulic signals, voltage signals, current signals, CAN messages, optical signals, radio signals), and to output command or communication signals in various formats (e.g., hydraulic signals, voltage signals, current signals, CAN messages, optical signals, radio signals).

The controller 66 may be in communication with other components on the work machine 100, such as hydraulic components, electrical components, and operator inputs within an operator station of an associated work machine. The controller 66 may be electrically connected to these other components by a wiring harness such that messages, commands, and electrical power may be transmitted between the controller 66 and the other components. Although the controller 66 is referenced in the singular, in alternative embodiments the configuration and functionality described herein can be split across multiple devices using techniques known to a person of ordinary skill in the art.

The controller 66 may be embodied as one or multiple digital computers or host machines each having one or more processors, read only memory (ROM), random access memory (RAM), electrically-programmable read only memory (EPROM), optical drives, magnetic drives, etc., a high-speed clock, analog-to-digital (A/D) circuitry, digital-to-analog (D/A) circuitry, and any required input/output (I/O) circuitry, I/O devices, and communication interfaces, as well as signal conditioning and buffer electronics.

The computer-readable memory 90 may include any non-transitory/tangible medium which participates in providing data or computer-readable instructions. The memory 90 may be non-volatile or volatile. Non-volatile media may include, for example, optical or magnetic disks and other persistent memory. Example volatile media may include dynamic random-access memory (DRAM), which may constitute a main memory. Other examples of embodiments for memory 90 include a floppy, flexible disk, or hard disk, magnetic tape or other magnetic medium, a CD-ROM, DVD, and/or any other optical medium, as well as other possible memory devices such as flash memory.

The controller 66 includes the tangible, non-transitory memory 90 on which are recorded computer-executable instructions, including a monitoring algorithm 92. The processor 88 of the controller 66 is configured for executing the monitoring algorithm 92. The monitoring algorithm 92 implements a method of monitoring and/or detecting objects 85 near the work machine 100.

As such, a method 600 may be embodied as a program or algorithm operable on the controller 66. It should be appreciated that the controller 66 may include any device capable of analyzing data from various sensors, comparing data, making decisions, and executing the required tasks.

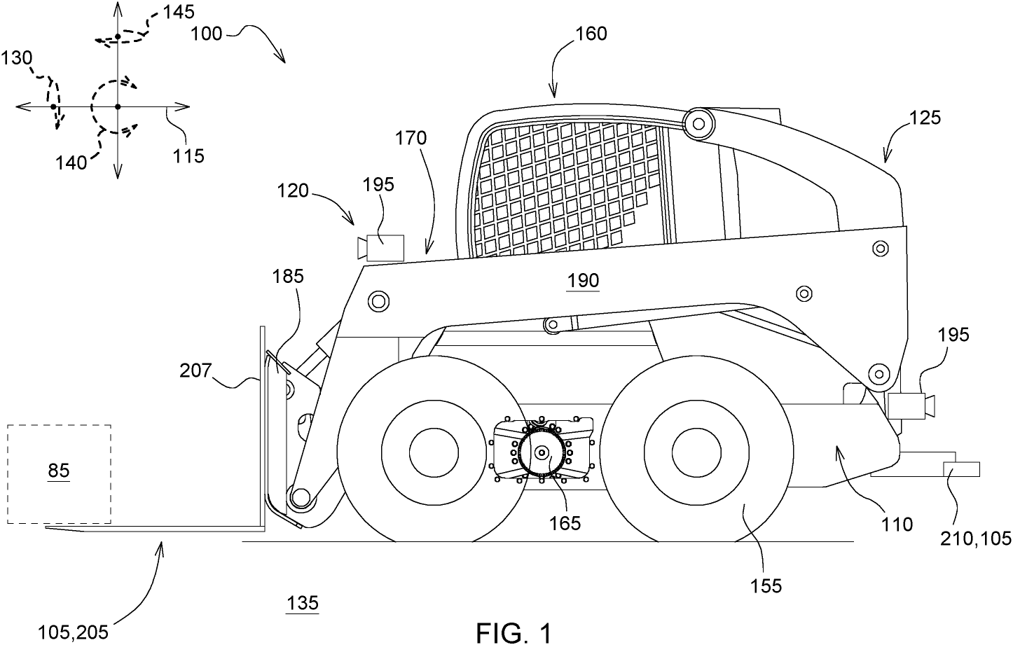

Referring now to the drawings, FIG. 1 illustrates a work machine 100, extending in a fore-aft direction 115, depicted as a skid steer with an attachment 105 operatively coupled to the work machine 100. It should be understood, however, that the work machine 100 could be one of many types of work machines, including, and without limitation, a skid steer, a backhoe loader, a front loader, a bulldozer, a tractor, a baler, a sprayer, and other construction or agricultural vehicles. The work machine 100, as shown, has a frame 110, having a front-end section 120, or portion, and a rear-end portion 125. The work machine 100 includes a ground-engaging mechanism 155 that supports the frame 110 and an operator cab 160 supported on the frame 110. The operator cab 160 is optional if the cab is operated remotely and/or autonomously. The ground-engaging mechanism 155 may be configured to support the frame 110 on a surface 135.

A power source 165 is coupled to the frame 110 and is operable to move the work machine 100. The illustrated work machine 100 includes wheels, but other embodiments may include one or more tracks or wheels that engage the surface 135. In this exemplary embodiment, the ground-engaging mechanism 155 on the left side of the work machine 100 may be operated at a different speed, or in a different direction, from the ground-engaging mechanism 155 on the right side of the work machine 100. In a conventional skid steer, the operator can manipulate controls from inside an operator cab 160 to drive the wheels on the right or left side of the work machine 100 using a control device such as a joystick, a foot pedal, a touchscreen, and a steering wheel. The movement for work machine 100 may be referred to as roll 130 or the roll direction, pitch 140 or the pitch direction, and yaw 145 or the yaw direction.

The work machine 100 comprises the boom assembly 170 coupled to the frame 110. The attachment 105 (may also be referred to as work tool) may be coupled at a forward portion of the boom assembly 170 (e.g. a forklift) or alternatively in the rear portion of the frame 110 (e.g. a hitch 210), while the rear portion of the boom assembly 170 is pivotally coupled to the frame 110. The attachment 105 at the forward portion of the boom assembly 170 may be coupled through an attachment coupler 185, an industry standard configuration or a coupler universally applicable to many Deere attachments and several after-market attachments.

The boom assembly 170 of the exemplary embodiment, comprises a first pair of boom arms 190 (one each on a left side and a right side) pivotally coupled to the frame 110 and moveable relative to the frame 110 by a pair of boom hydraulic actuators (not shown), wherein the pair of boom hydraulic actuators, may also be conventionally referred to as a pair of lift cylinders (one coupled to each boom arm) for a skid steer. The attachment coupler 185 may be coupled to a forward section, or portion, of the pair of boom arms 190, being moveable relative to the frame 110 by a pair of tilt hydraulic cylinders (not shown). The frame 110 of the work machine 100 further comprises a hydraulic coupler (not shown) on the front-end portion 120 of the work machine 100 to couple one or more auxiliary hydraulic cylinders to drive movement of or actuate auxiliary functions of the attachment 105. The hydraulic coupler, contrary to the attachment coupler 185, enables the hydraulic coupling of the hydraulic actuators(s) on the attachment 105 to a hydraulic system of the work machine 100. Please note that not all attachments have one or more auxiliary hydraulic cylinders and therefore will not use the hydraulic coupler. Alternatively, uses for the hydraulic coupler add another form of movement such as lifting or lowering a forklift 205, opening or closing a grapple type attachment, spinning a rotary drum, or turning the cutting teeth on a trencher, to name a few. An image sensor 195 may be coupled to one or more of the boom assembly 170 and the frame 110, in a direction oriented towards the attachment 105, or the direction of the attachment 105. In one embodiment, the image sensor 195 may comprise of one or more cameras coupled to portions of the frame, or other immoveable parts of the work machine 100, and toggle between cameras as the boom assembly 170 moves to acquire a seamless image of the attachment 105. In another embodiment, the image sensor 195 may be coupled to the boom assembly 170, a moveable part of the work machine, to view the attachment.

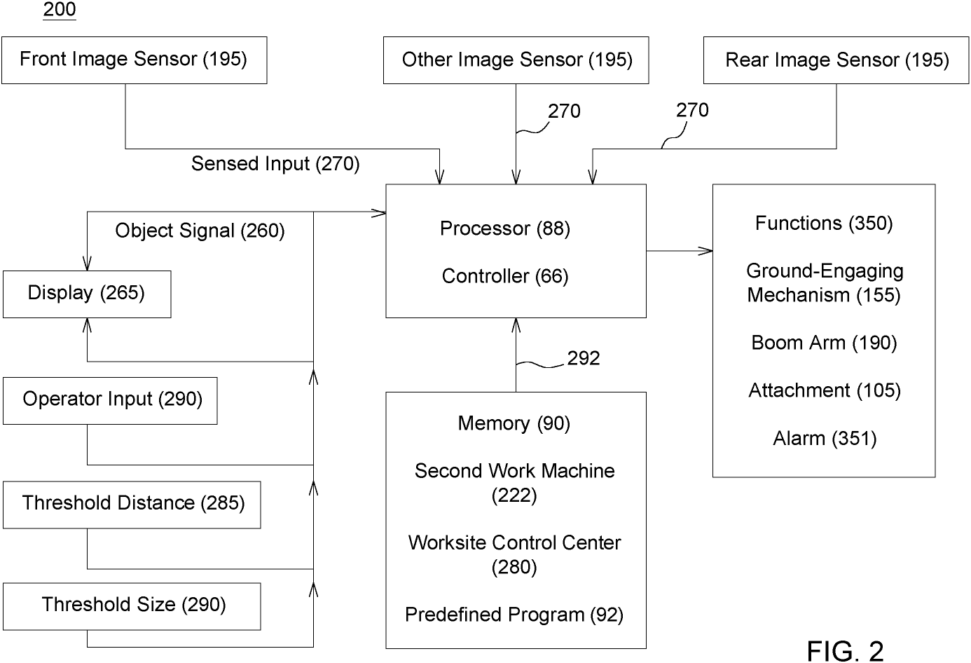

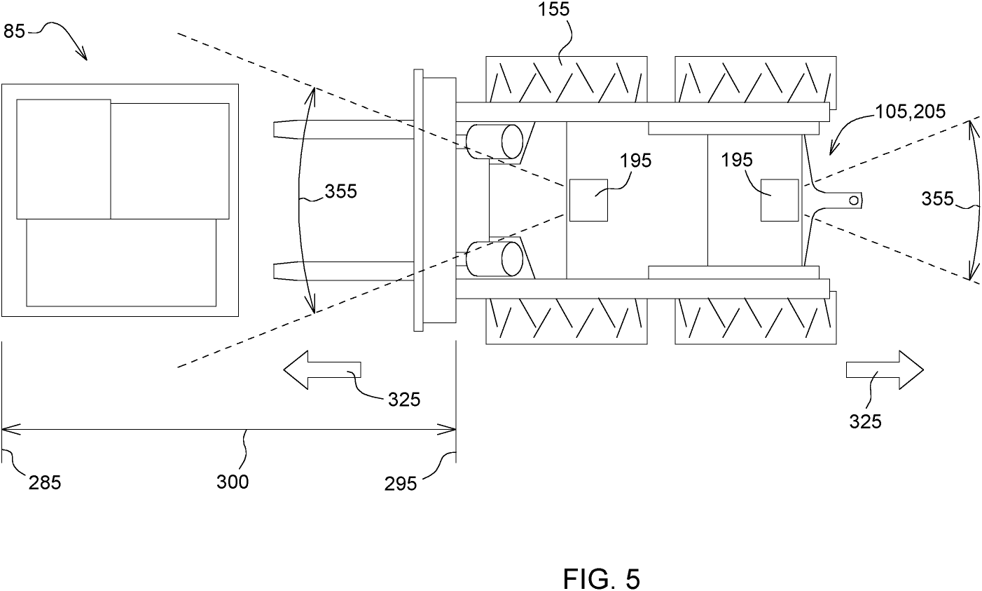

FIG. 2 is a block diagram of the system architecture and the flow of the disclosed object detection system 200. The system comprises an image sensor 195, the attachment 105, a processor 205, and the controller 66. The image sensor may include one or more sensors (e.g. a front image sensor, a rear image sensor, or others image sensors in alternative directions). Again, the image sensor 195 may be coupled to one or more of the boom assembly 170 and the frame 110, in a direction oriented towards the attachment 105, or in the direction of the attachment 105. The image sensor 195 may be configured to detect an object 85 around the work machine 100 (i.e. at minimum provide a sensed input 270 (shown in FIG. 2) to derive a detection of an object 85 when an object is present). The image sensor 195 may be oriented towards the attachment along the direction of travel or travel path 325 (shown in FIG. 5 from a top view of the work machine 100. As will be described in further detail later herein, the number and configuration of sensors 195 used to detect the objects 85 may be varied as needed or desired based on one or more parameters of the attachment. For example, the image sensors 195 may be positioned relative to each other so that an appropriate amount of sensitivity, accuracy and/or resolution may be provided between the sensors along an axial width or axial length of the attachment such that any object 85 may be effectively detected. Exact placement of the image sensors 195 may vary depending on the work machine applied thereto.

The image sensor 195, generating a sensed input 270, may give a line-of-sight toward the attachment 105 or ground surface 135, and objects 85 around the work machine 100. The image sensor 195 may be utilized to detect objects 85 within a certain detection distance of the work machine 100. In one embodiment, the detection distance may be determined by the capabilities of the image sensor 195. In normal operation, the image sensor 195 may be configured to detect an object 85 closer than a distance threshold 285 from either the work machine 100 or the image sensor 195 itself. The distance threshold 285 may be pre-set or adjustable to avoid the anticipated/known ground surface irregularities from setting off the image sensor 195. Image sensor 195 may also be configured to require a detected object 85 be larger than a threshold size 290 before being considered an object 85, and this threshold size 290 may be pre-set or adjustable, based on the distance to the object from a reference point 295 or reference plane. In one exemplary embodiment, the reference point 295 may be a portion of the work machine 100, such as the frame 110, the boom assembly 170, the attachment coupler 185, or the attachment 105. Alternatively, the reference point 295 may be a point where the ground-engaging mechanism 155 engages the ground surface 135. In yet another alternative embodiment, the reference point 295 may be the image sensor 195 itself, or a receiving counterpart to the image sensor 195.

Image sensors 195 may be communicatively coupled to a processor 88 on the work machine 100 (alternatively, the processor 88 may be a part of the image sensor 195 itself or a worksite control center 280) that analyzes the sensed input 270 to determine whether an object 85 is present in the area and then communicates an object signal 260 indicative of the presence of an object 85 to a display 265. In one exemplary embodiment, the object signal 260 derived from the sensed input 270 from the image sensor 195 may be a value which indicates the absence of an object 85 (e.g. 0) or the proximity of the object 85 to the image sensor 195 (e.g. 1, 2, or 3 as the proximity increases). In alternative embodiments, the object signal 260 from the image sensor 195 may not itself communicate the presence or absence of an object 85 in an area but may instead communicate a value representative of the signal strength. In another embodiment, the object signal 260 may be derived from the dimensional attributes of an image where a distance and/or size of an object 85 may be calculated based on the known reference point 295 by the processor 88. The processor 88 may be communicatively coupled to the image sensor 195 to process the sensed input 270 into an object signal 260. In one embodiment, the processor 88 may be configured to monitor the object signal 260 in real-time to detect an object 85.

The object 85 may be in the path of travel 325 of the attachment 105. The processor 88 may determine a distance between the object 85 and a distance threshold 285, wherein the distance threshold 285 is a predefined distance for the controller 66 to recognize it is about to engage with an object 85 and therefore alter one of the speed of the work machine 100, and a position of the implement 105. The image sensor 195 may communicate other data to allow the controller 66 to interpret whether an object 85 is present in the area. Image sensor 195 may communicate further information such as the size of, distance to, or movement of the detected object(s), to enable the controller 66 to take different actions based on the size, distance, or movement of the detected object(s) 85. This information can be pictorial image, a simple camera image, or a combination of both.

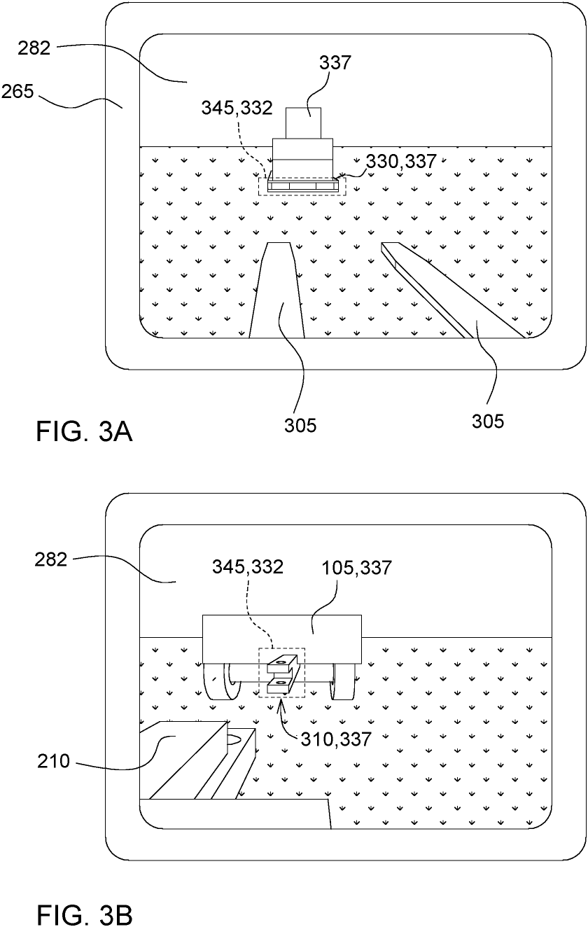

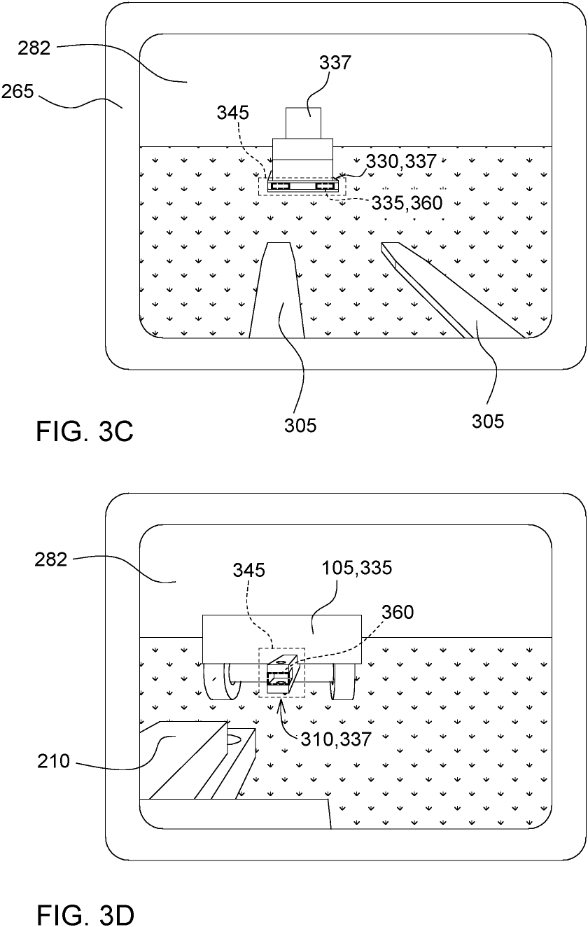

As previously mentioned, the attachment 105 may be coupled to one or more of the boom assembly 170 and the frame 110. Within the application of the object detection system 200, the attachment 105 may be stationary or may be moving. For example, the forklift 205 shown is coupled to a front-end section 120 of the work machine 100. A mast 207 is a post coupled to a front surface of the frame 110, and its axis extends in an up and down direction. The fork is mounted to the mast 207 by being able to move in the up and down direction. Further, the fork is capable of swinging with respect to the mast 207 by a tilting mechanism in the direction of tilt 130. The fork includes a pair of tines 305 (shown in FIGS. 3A and 3B). The tines 305 are disposed at positions spaced apart from each other in a right-and-left direction relative to the frame 110 and extend forward of the work machine from a mast side. A lift chain is disposed on the mast 207 and is engaged with the fork. When the lift chain is actuated, the fork is lifted and lowered according to a motion thereof. The forklift is then used to engage with an object 85 such shown in FIGS. 3A and 3B as a pallet 330 for transport to another location.

In another exemplary application the attachment 105 is a hitch. The hitch 210, may be mounted on a rear portion of the work machine 100 to couple the work machine to another work machine, a trailer, or tool. In one exemplary embodiment, the hitch 210 may be raised by a piston movement of a hydraulic cylinder (not shown) when hydraulic oil is supplied into the hydraulic cylinder by a hydraulic pump (not shown). The hitch 210 may be a single point hitch. In another embodiment, the hitch 310 may be a three-point hitch including an upper link and a lower link. These are a few of several industry standard hitch configurations available with the use of work machines.

Depending on the application of the object detection system 200 and the work machine the object detection system is coupled to, the image sensor 195 may be one or more of forward facing and rear facing. However, alternative embodiments are not limited to either of the two directions. For example, a work machine, such as an excavator with an ability to rotate an attachment about a vertical axis 360 degrees, may have image sensors 195 in multiple direction if coupled to the base frame.

Processing of the object signal 260 include one or more of recognizing an object 85 in the image 282 (derived from the sensed input 270 and shown on a display 265) and defining the recognized object 337 as a target object 335. The processor 88 may define a bounded area 345 in the image 282 around the target object 335 and operate the work machine 100 wherein the object detection system 200 is configured to execute a function 350 of the work machine 100 when the target object 335 is defined. For example, the bounded area 345 may include a perimeter of the object 85, an area around the object or merely the intended contact area 360. The display device 265 may show an icon 332 representing the recognized object. In the display device 265, an icon 332 is an image that represents an object, an application, a capability, or some other concept or specific entity with meaning for the operator. This can include an image of the object itself, or an altered image representative of said object.

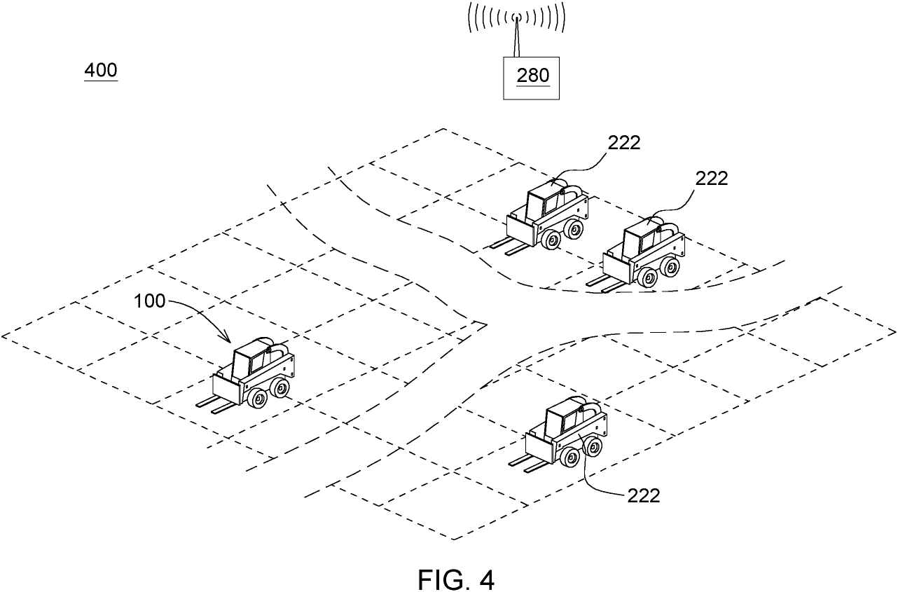

FIGS. 3A and 3B display the icon 332 as a dotted rectangle. Recognition of the target object 335 may be done with operator input 290 by manually selecting an icon 332 displayed on the display device. Alternatively, recognition of a recognized object 337 as the target object 335 may be processed automatically wherein defining the recognized object 337 as the target object 332 is based on one of identification as an object stored in a memory 90, or as a previously recognized object 337. The object stored in memory may further be received from a second work machine 222, a worksite control center 280, or a predefined program 92. The sharing of information between work machines enables a safe cycle, swarm, or hive-minded type group movement wherein a learned target object 332 is remembered, and the information is shared to other work machines or intermediaries (such as a cloud or device) at a worksite 400. In one exemplary embodiment, target object selection may eventually become learned with repetitive operator selection or learned based on repeated targeting of an object 85 at particular worksite locations. Learned target object selection 292 can be further defined through worksites, the operating company, the fleet type of the work machines, the operative stage of construction or agricultural operation, or operator preferences. The learned target object selection 292 may also advantageously supplement worksite operations in weather conditions with low visibility. FIG. 4 is a bird’s eye view of a worksite 400 demonstrating areas where work machines are parked along with their relative travel routes. On an instance of a foggy day, learned target object selection 292 may assist in moving the pallets from a first location to a second location, or for example, assist with coupling the work machine 100 to an attachment 105. In such crowded or busy areas, targeting objects will advantageously serve a passive role for object avoidance, or an active role for object engagement. In a passive role, the targeted objects may be ignored in a standard object detection system 200, thereby eliminating any false positives. In an active role, the targeted object may be the object 85 the work machine is performing a function 350 relative to.

FIGS. 3A and 3B are exemplary views on a display 265 showing the field of view 355 from the image sensor 195 with a recognized object 337 in view. FIG. 3A shows the field of view with tines of a forklift about to engage with a pallet 330 carrying a payload. In this embodiment, FIG. 3A is representative of a forward-facing view from an image sensor 195. FIG. 3B shows the field of view 355 of the hitch 210 to engage with a trailer coupler 310 of an attachment 105, such as a trailer. FIG. 3B shows a field of view 355 from a rear-facing image sensor 195. In this particular embodiment, FIGS. 3C and 3D demonstrate the fields of view 355 with a recognized object 335 as defined by dotted lines. Once the objects are recognized, an operator, or alternatively data driven from an alternative resource, the one or more recognized objects 337 may be selected as the target object 335. In FIG. 3C, the target object 335 as shown in the exemplary embodiment is defined by the bold line. An operator, for example, may touch a touchscreen to either select or deselect an icon 332 as the target object 335. FIG. 3C demonstrates the target object as the pallet spaces and an intended contact area 360 located where the tines 305 will engage the pallet 330 demonstrating an active role in the object detection system 200. FIG. 3D demonstrates the target object 335 as the trailer coupler 310 on an attachment 105 to which the hitch 210 engages. In this example, the target object 335 can be the attachment 105 (i.e. trailer) wherein the object detection system 200 demonstrates a passive role (i.e. ignoring the attachment 105).

FIG. 5 shows a top view of a work machine 100 with the object detection system 200, shown here as a skidder. Recognition of the at least one object occurs within a defined space relative to the work machine wherein the defined space includes a predefined distance 285 from the work machine 100, attachment 100, or image sensor 195. A target object 335 may become untargeted if the target object falls outside a field of view 355 of the image sensor, or a predefined window on the display device 265. The window can be a subset of the field of view 255. The predefined distance 285 (also referred to as the threshold distance) may be, for example, five meters. For example, if an operator has identified an intended area of contact 360, but then the vehicle turns where the intended area of contact 360 falls outside the field of view 355 or falls away from a predefined distance 285 from the work machine, the targeted object may reset to simply a recognized object 337. This may advantageously serve well between shift transitions, personnel changes, or any other disruption anticipating a need to reconfirm a recognized object 337 as a target object again.

The controller 66 may be communicatively coupled to the processor 88 wherein the controller 66 sends a control signal 365 to one or more of a machine control system and the attachment control system to modify one or more of the movement of the attachment 105 and movement of the work machine 385 based on the object 85 reaching the distance threshold 285. In one instance, the attachment 105 may be powered by the work machine 100 and thereby be controlled by the machine control system. Alternatively, it may be self-powered through it’s own power source such as an battery and controlled through an attachment control system.

The processor 88 subsequently overrides execution of a function 350 of the work machine 100 when the object is defined as the target object. A function 350 of the work machine 100 may include one of alerting the operator 351, stopping the work machine 155, modifying a current travel speed of the work machine 155, and steering the work machine 155. Another function may include modifying the movement of the work machine 100 including one or more of several work machine parameters. The first may be modifying a speed of one or more of the left ground-engaging mechanism and the right ground-engaging mechanism of the work machine 100. For example, upon identifying a target object 335, the work machine 100 may begin slowing down for object engagement type applications. The relative motions of both the left ground-engaging mechanism and the right ground-engaging mechanism 155 can also translate into a degree of a change in direction of the work machine. Another may include pausing the work machine 392, thereby halting potential collision. Another may include modifying an acceleration 393 of the work machine 100. In the first embodiment of a skid steer, the work machine 100 may also modify the pitch 140 of the boom arms 190 to position an attachment for coupling to an intended contact area 360.

Modifying the movement of the attachment 105 comprises one or more of several other parameters 390 including pausing movement, and modifying the roll 130, yaw 140, and pitch 140, to name a few.

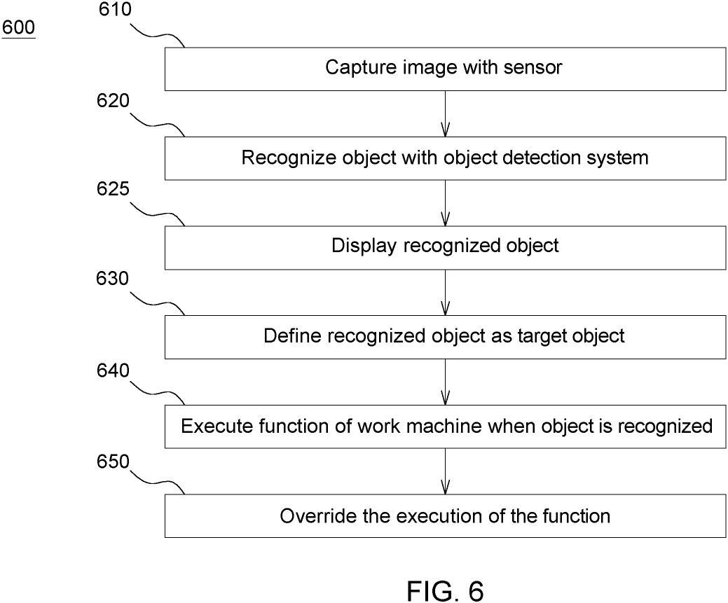

Now turning to FIG. 6, a method 600 of controlling a work machine 100 having the object detection system 200 is disclosed. In a first step 610, the method comprises capturing an image with an image sensor 195. The image may be derived from sensed input 270. In step 620, the object detection system recognizes an object 85 in the image. Step 630 discloses defining the recognized object 337 as a target object 335. In step 640, the work machine is operated wherein a function of the work machine is executed based on the target object 335. Step 650 includes overriding the execution of the function of the object detection system 200 (or alternatively the work machine 100) when the object 85 is defined as the target object 335. In one particular embodiment, prior to executing a function of the work machine, in step 625, an icon representing the recognized object 337 is displayed on a display device 265.

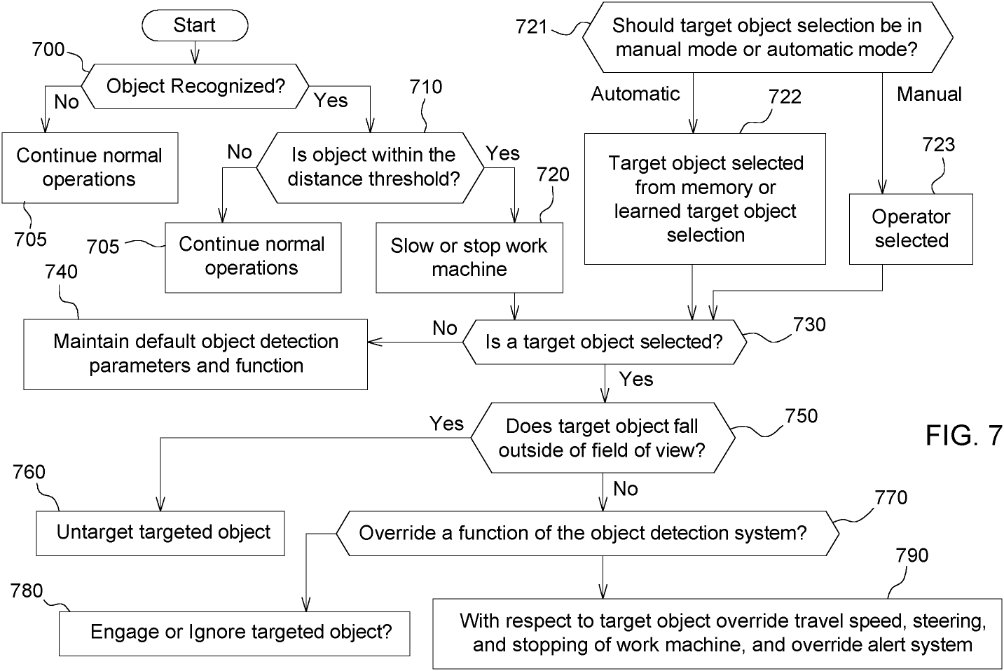

FIG. 7 is a flow diagram illustrating one embodiment of the object detection system 200. In a first step 700, a processor 88 on the controller 66 determines whether an object 85 is recognized. If not, the work machine 100 continues normal operations as in step 705. If an object 85 is recognized based on the sensed input 270 of the image sensor 195, the processor then determines if the object is within a distance threshold 285 as in step 710. In one example, the distance threshold 285 may be five meters, or alternatively ten meters, or merely one meter. If the object 85 is not within a distance threshold 285, the work machine may continue normal operations. If the object is at or within the distance threshold 285, the work machine may approach more cautiously by either slowing or stopping the work machine as in step 720. If a recognized object 337 is not selected as a target object 335, the work machine 100 maintains the default object detection parameters and function per step 740. For example, the work machine 100 may alert an operator when an object 85 is recognized or avoid the object when the object is recognized. Alternatively, if a target object is selected in step 730 and remains in the field of view 355, a function of the object detection system 200 may be override as in step 740. The processor 88 may direct the object detection system 200 to ignore the target object and deactivate the alarm with respect to the selected object. Alternatively, processor 88 may direct the work machine 100 to intentionally engage with the target object 335. In another embodiment, the processor 88 may override a function 350 of the work machine with respect to its position relative to the target object 335. That is, it may override a travel speed, steering, halt the work machine, or override the alert system, to name a few. However, if the target object 335 falls outside the field of view 355, the target object 335 may reset, and become untargeted as shown in step 760.

As used herein, “e.g.” is utilized to non-exhaustively list examples, and carries the same meaning as alternative illustrative phrases such as “including,” “including, but not limited to,” and “including without limitation.” As used herein, unless otherwise limited or modified, lists with elements that are separated by conjunctive terms (e.g., “and”) and that are also preceded by the phrase “one or more of,” “at least one of,” “at least,” or a like phrase, indicate configurations or arrangements that potentially include individual elements of the list, or any combination thereof. For example, “at least one of A, B, and C” and “one or more of A, B, and C” each indicate the possibility of only A, only B, only C, or any combination of two or more of A, B, and C (A and B; A and C; B and C; or A, B, and C). As used herein, the singular forms “a”, “an” and “the” are intended to include the plural forms as well, unless the context clearly indicates otherwise. Further, “comprises,” “includes,” and like phrases are intended to specify the presence of stated features, steps, operations, elements, and/or components, but do not preclude the presence or addition of one or more other features, steps, operations, elements, components, and/or groups thereof.

1. A method of controlling a work machine having an object detection system, the method comprising:
capturing an image with an image sensor;
recognizing an object in the image with the object detection system;
defining the recognized object as a target object;
operating the work machine, wherein the object detection system is configured to execute a function of the work machine when the object is recognized; and
overriding the execution of the function of the object detection system when the object is defined as the target object.

2. The method of claim 1 further comprising displaying an icon representing the recognized object on a display device.

3. The method of claim 2 wherein defining the recognized object as the target object includes selecting the icon displayed on the display device.

4. The method of claim 3 wherein selecting includes an operator manually selecting the icon.

5. The method of claim 1 wherein defining the recognized object as the target object includes the object detection system automatically defining the recognized object as the target object based on one of identification as a pre-defined object stored in a memory, or identification as a previously defined target object.

6. The method of claim 5, wherein the object stored in memory is received from one of a second work machine, a worksite control center, and a predefined program.

7. The method of claim 1, wherein recognition of the object occurs within a defined space relative to the work machine, the defined space being up to a predefined distance from one of the work machine, attachment, or image sensor.

8. The method of claim 1, wherein the target object is untargeted if the target object falls outside a field of view on the display device.

9. The method of claim 1, wherein the function of the object detection system comprises one or more of object avoidance and object engagement.

10. The method of claim 1, wherein the function of the object detection system includes one of alerting an operator, stopping the work machine, modifying a current travel speed of the work machine, and steering the work machine.

11. The method of claim 1 further comprising selecting a work machine mode for a desired operation.

12. The method of claim 1 further comprising transmitting the defined target object to one of a second work machine and a location remote from the work machine.

13. An object detection system for a work machine, system comprising:
a frame;
a boom arm coupled to the frame;
an image sensor coupled to one or more of the boom arm and the frame, the image sensor capturing an image;
a processor communicatively coupled to the image sensor, the processor recognizing an object in the image; and
a controller operating the work machine, wherein the controller is configured to:
execute a function of the work machine when the object is recognized; and
override the execution of the function of the work machine when the object is defined as the target object.

14. The system of claim 13 further comprising a display device, the display device displaying an icon representing the recognized object on a display device.

15. The system of claim 14, wherein defining the recognized object as the target object includes manually selecting the icon displayed on the displace device.

16. The system of claim 14, wherein defining the recognized object as the target object includes the controller automatically defining the recognized object as the target based on one of identification as a pre-defined object stored in a memory, or identification as a previously defined target object.

17. The system of claim 16, wherein the object stored in memory is received from one of a second work machine, a worksite control center, and a predefined program.

18. The system of claim 13, wherein recognition of the object occurs within a defined space relative to the work machine, the defined space being up to a predefined distance from the work machine.

19. The system of claim 13, wherein the target object is untargeted if the target object falls outside a field of view on the display device.

20. The system of claim 13, wherein the function of the work machine comprises one of alerting an operator, stopping the work machine, modifying a current travel speed of the work machine, and steering the work machine.
